(19) United States
(12) Patent Application Publication
(10) Pub. No.: US 2008/0184073 A1
(43) Pub. Date: Jul. 31, 2008

(54) Power on self test method

(75) Inventors: Chih-Wei Wang, Taipei (TW); E-Min Lin, Taipei (TW); Kuo-Wei Huang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/700,082

(22) Filed: Jan. 31, 2007

(51) Int. Cl. G06F 11/00

(52) U.S. Cl. 714/36; 714/E11.001

(57) ABSTRACT

A power on self test (POST) method is provided. The method is a hardware detecting program applicable for a BIOS of a computer, which requires loading a detecting firmware. The method includes steps (a) running a POST program; (b) testing a hardware device by a first sequence of detecting firmware when running to a hardware detecting program of the POST program; (c) when the hardware testing program sends back an error value, outputting an error message corresponding to the hardware testing program to a memory; (d) re-booting the computer, loading next sequence of detecting firmware to the BIOS, and running the hardware testing program by the next sequence of detecting firmware; and (e) continuing to run the POST program when the hardware testing program sends back a correct value, if the hardware testing program still sends back an error value in Step (e), the process goes back to Step (c).

### BACKGROUND OF THE INVENTION

1. Field of Invention

The present invention relates to a power on self test (POST) method, and more particularly, to a POST method that is capable of conducting detection repeatedly by adjusting a detecting configuration.

2. Related Art

During the current process of developing basic input/output programs, testing persons test a hardware device through several times of rebooting program and several times of Power On Self Test (POST) program, so as to verify the basic input/output system (BIOS) programs or to look for other errors. The main task of the POST program is to detect whether some critical devices (for example, a memory and a display card) in a computer system are existed or not and whether they are operated normally or not. However, most of the above testing processes are recorded and tested manually (for example, manual rebooting), which thus needs to be improved in terms of testing quality, efficiency, and reliability.

With reference to Taiwan Patent Publication No. 200619965, it discloses a method for rapidly completing the POST of a computer system. Firstly, upon receiving a booting signal, power-on configuration data obtained by normal POST are run. Then, a rapid power-on tag is added into the computer system, which indicates that the power-on configuration data have already been stored in the computer system. When the power-on signal is received again, it is detected whether the computer system has the rapid power-on tag or not. If the computer system has the rapid power-on tag, the power-on configuration data in the storage device is read, and a rapid power-on configuration recovery program is run to rapidly achieve the POST process of the computer system.

The above patent application has shortened the testing time course, but cannot automatically record the relevant error message, and thus, it is not suitable for testing programs, which need to conduct the program verification.

With reference to Taiwan Patent Publication No. 200426581, it discloses a method for recording the schedule for the power on test, wherein test schedules for internal elements or operating systems for each test are recorded in a specified format and stored in the storage device each time when the POST program is run for testing the computer, which serve as important reference indexes for the maintenance by a maintenance person, or for the manufacturing operations in the computer manufacturing field later.

In the above patent application, the testing is performed for several times and each testing result is automatically recorded, but it fails to provide a plurality of configuration values for repeatedly testing each hardware device. Therefore, the requirement for assisting the detecting person to find out the exact error and provide an effective improving scheme cannot be met. So the above methods still need to be improved.

Therefore, it has becomes one of the problems to be solved by researching persons how to provide a POST method that automatically detects the hardware device for several times using detecting firmware of various versions and thereby saving the labor cost and shortening the testing time course.

### SUMMARY OF THE INVENTION

In view of the above problems, the present invention is directed to providing a power on self test (POST) method, which automatically detects the hardware device for several times by using detecting firmware of various versions and records an error message generated during each detecting process, and thereby saving the testing labor cost and shortening the testing time course.

The POST method disclosed according to the present invention is a hardware detecting program applicable for the basic input/output system (BIOS) of the computer, which requires loading a detecting firmware. The method includes the following steps. Firstly, (a) a POST program is run. (b) At least one hardware device is tested by a first sequence of detecting firmware, when running to the hardware detecting program of the POST program. (c) An error message corresponding to the hardware testing program is output to a memory when the hardware testing program sends back an error value. Then, (d) the computer is rebooted, and the next sequence of detecting firmware is loaded to the BIOS from the memory to run the hardware testing program. (e) The POST program is continued when the hardware testing program sends back a correct value; wherein if the hardware testing program still sends back the error value in Step (e), it goes back to Step (c).

By using this POST method, the manual procedures that must be originally recorded by the testing person are achieved by a computer program, and thus the manual operation error problem is avoided. Besides, the hardware device is automatically detected for several times by detecting firmware of various versions, thus greatly improving the testing efficiency. Moreover, the testing person finds out the reason for the error occurred to the hardware device more precisely through viewing the error message generated during each detecting process, and thereby achieving the object of saving the labor cost, shortening the testing time course, and enhancing the testing reliability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of an embodiment of the present invention;

FIGS. 2A and 2B are detailed flow charts for Step 107 of an embodiment of the present invention; and

FIG. 3 is a schematic view of an embodiment of the present invention.

### DETAILED DESCRIPTION OF THE INVENTION

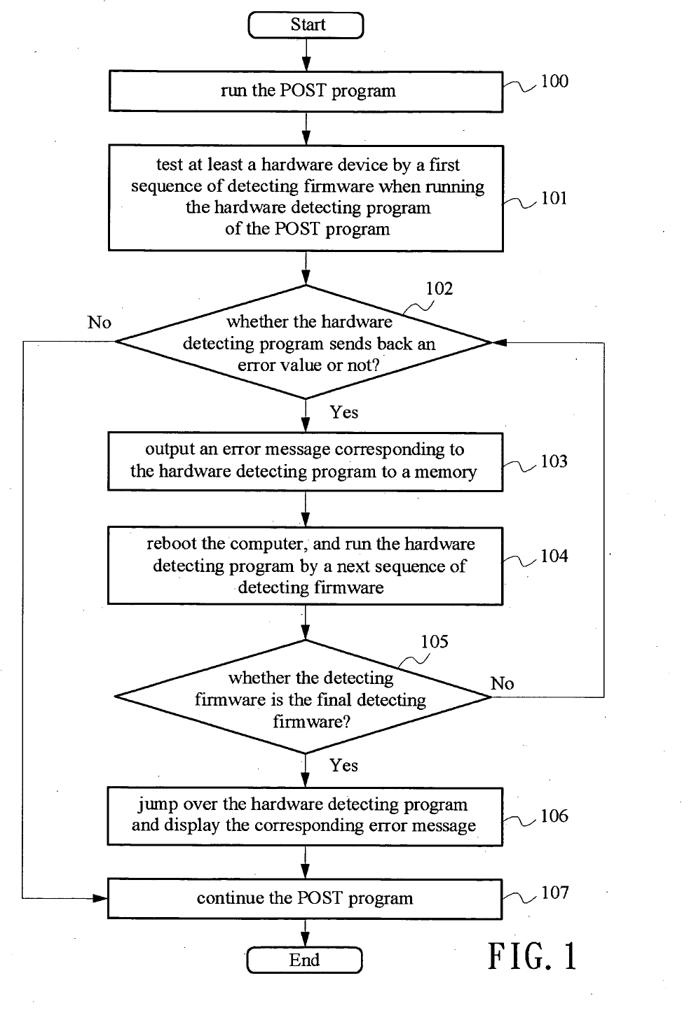

Referring to FIG. 1, it is a flow chart of an embodiment of the present invention. As illustrated in FIG. 1, the POST method of the present invention is a hardware detecting program applicable for the basic input/output system (BIOS) of a computer, which requires loading a detecting firmware. The method includes following steps.

Firstly, the BIOS runs the POST program (Step 100), and when running to the hardware detecting program of the POST program, at least a hardware device is tested by a first sequence of detecting firmware (Step 101). The above described “sequence” in the first sequence of detecting firmware refers to a corresponding address sequence for the detecting firmware to be stored in the memory. Alternatively, the first sequence of detecting firmware also can be considered as a firmware program of the latest version.

Next, it is determined whether the hardware testing program sends back an error value or not (Step 102). The hardware testing program sends back the error value when the detecting firmware is not compatible with the hardware device. When the hardware testing program is confirmed to send back the error value, an error message corresponding to the hardware testing program is output to the memory (Step 103). The error message includes an error occurring time data, an error occurring times data, and a detecting firmware version data. In practice, the error message is stored in an error message recording register of the memory.

Then, the computer system is rebooted, a next sequence of detecting firmware is loaded into the BIOS from the memory, and the hardware testing program is run by the next sequence of detecting firmware (Step 104). The above described “sequence” in the next sequence of detecting firmware refers to a corresponding address sequence for the detecting firmware to be stored in the memory. Alternatively, the next sequence of detecting firmware also can be considered as the firmware program of the latest version.

Then, it is determined whether the loaded next sequence of detecting firmware is the final detecting firmware or not (Step 105). When the detecting firmware is determined to be the final detecting firmware, the hardware detecting program is jumped over, and the error message corresponding to the error of the hardware testing program is read from the memory and displayed (Step 106). In practice, the relevant error message is displayed through a display device. When the detecting firmware is determined not to be the final detecting firmware, it goes back to Step 102.

When the hardware testing program sends back a correct value, the POST program is continued (Step 107). If the hardware testing program still sends back the error value in Step 107, it goes back to Step 103, and the error message corresponding to the hardware testing program is output to the memory.

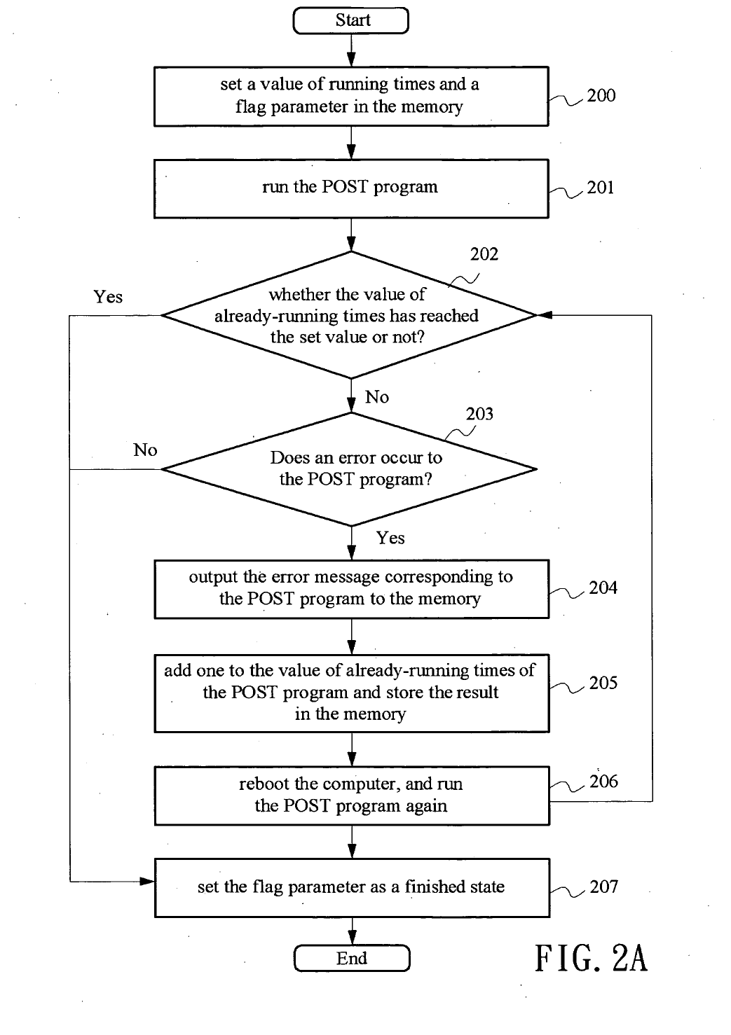

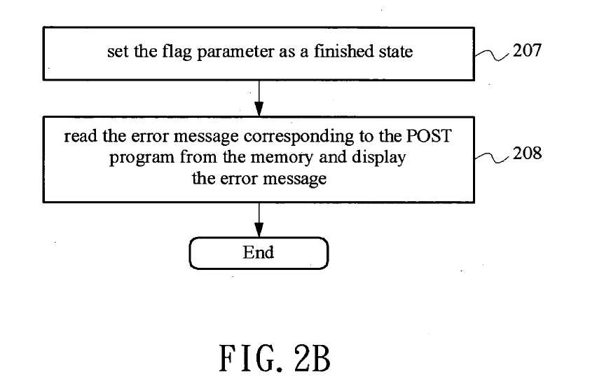

Besides, referring to FIGS. 2A and 2B, they are flow charts of the POST method after Step 107. As showed in FIG. 2A, the POST method of the present invention further includes following steps.

Firstly, a value of running times and a complete flag value are set in the memory when the computer is booted for the first time (Step 200). In practice, variables corresponding to the value of running times and the flag parameter are added in the BIOS program, and one block is divided in the memory to store the value of running times and the flag parameter. The memory is preferred to be a non-volatile memory (NVRAM), for example, a flash memory, or a volatile memory, for example, a dynamic random access memory (DRAM).

Then, the computer runs the POST program via the BIOS program (Step 201). In the BIOS program of an embodiment of the present invention, each hardware device to be detected has its corresponding detecting firmware with different versions, so as to run various detecting programs. The value for the already-running times for the current POST program is read from the memory to determine whether the value of the already-running times of the POST program has reached the set value of running times or not (Step 202). If the value of the already-running times of the POST program is determined not to reach the set value, it is determined whether an error occurs to the POST program or not (Step 203). In practice, the state of the hardware device to be tested is determined to meet the requirements or not through a data responded by the hardware device to be tested.

When an error occurs to an item of the POST program, the error message corresponding to the POST program is output to the memory (Step 204). Upon receiving the error message, the memory stores the data. The error message includes an error occurring time data, an error occurring times data, and a hardware device configuration data. When no error occurs to the POST program, the flag parameter is set to a complete state (Step 207).

Then, the value of already-running times of the POST program is added by one and then stored in the memory (Step 205), wherein the value of the already-running times of the POST program is adjusted by way of accumulating or inverse accumulating. For example, as for the accumulating manner, when the set value of running times is 10 and the value of the already-running times is 0, each time when the POST program is operated once, the value of the already-running times is added by one, and the detecting program is not ended until the value of the detecting times reaches 10. Similarly, Step 205 also can be achieved through the inverse accumulating manner.

Then, the BIOS program reboots the computer automatically, and runs the POST program once again (Step 206). It goes back to Step 102 to determine again whether the value of the already-running times of the POST program has reached the set value or not. If the value of the already-running times of the POST program reaches the set value, the flag parameter is set as the complete state (Step 207). Then, referring to FIG. 2B, it is a detailed flow chart of Step 207. When all POST programs are completed, the flag parameter in the memory is set as the finished state (Step 207). Then, the error message corresponding to the error of the POST program is read from the memory and displayed (Step 208). In practice, the relevant error message is displayed by a display device, wherein the error message is displayed in batches according to the running sequence of the POST program, or displayed once entirely.

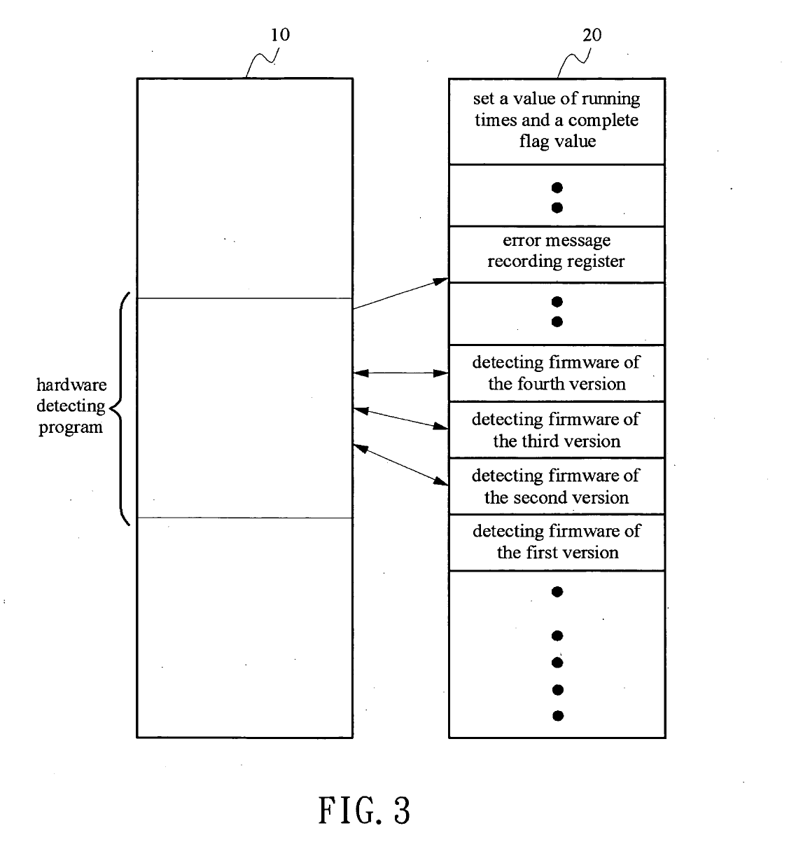

Referring to FIG. 3, it is a schematic view of an embodiment of the present invention. Firstly, the user adds a reboot option for the POST program to an ROM Base Setup Utility (RBSU), and sets the value of running times and the flag parameter of the POST program (preset as an unfinished state), and the above two values are stored in the memory 20. Then, the computer runs the BIOS program 10. When it runs to a detecting program for the first hardware device to be tested, it is determined whether the value of the already-running times of the current POST program has reached the set value or not. If the value of the already-running times of the current POST program doesn't reach the set value, it continues to determine whether an error occurs to the POST program or not. At this time, if an error occurs to the POST program, the BIOS program 10 outputs the error message (for example, the error occurring time, the error occurring times, and the hardware device configuration) to the memory 20 for being stored, and the value of the already-running times the POST program is added by one.

Then, the computer is rebooted, and the BIOS program 10 runs the POST program again, and continues to run the POST program after it is determined that the value of the already-running times of the current POST program doesn't reach the set value. At this time, when running the hardware detecting program, a compatibility problem occurs between the detecting firmware and the hardware device, and thus an error value is sent back. Then, the BIOS program 10 outputs the error message into the memory 20 for being stored. The computer is rebooted, and the BIOS program 10 loads a detecting firmware of the fourth version from the memory 20 to detect the hardware device. If the compatibility problem still occurs between the detecting firmware and the hardware device, the error value is sent back. Then, the BIOS program 10 outputs the error message to the memory 20 for being stored. The computer is rebooted, the BIOS program 10 loads the detecting firmware of the third version from the memory 20, and so forth. Till the detecting firmware is compatible with the hardware device or no detecting firmware of other versions exists, the error message corresponding to the error of the hardware testing program is displayed and the POST program is continued.

Each time when the POST program is finished, the computer determines whether the value of the already-running times matches with the set value. If the above set value is matched, the flag parameter in the memory 20 is set as a finished state and the POST program is ended. Finally, the relevant error message is displayed for the user to review.

Thus, by reading the error message from the memory 20, the detecting person easily gets to known the exact point of the error problem and the correct detecting firmware for being used. Because the error message is recorded in the memory 20, the reason for the problem can be known from the error message, and how to adjust the final configuration of the BIOS program 10 can be known through updating the version of the detecting firmware automatically.

Through such a POST method, the hardware device is tested for several times automatically through using detecting firmware of various versions. Besides, the error message generated in each testing process is recorded, such that the objective of saving the labor, shortening the testing time course, and enhancing the testing reliability is achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power on self test (POST) method, which is a hardware detecting program applicable for a basic input/output system (BIOS) of a computer and requires loading a detecting firmware, comprising:
(a) running a POST program for the BIOS;
(b) testing at least a hardware device by a first sequence of detecting firmware when running to a hardware detecting program of the POST program;
(c) outputting an error message corresponding to the hardware testing program to a memory when the hardware testing program sends back an error value;
(d) rebooting the computer, loading next sequence of detecting firmware to the BIOS from the memory to run the hardware testing program; and
(e) continue to run the POST program when the hardware testing program sends back a correct value;
wherein if the hardware testing program still sends back an error value in Step (e), the process goes back to Step (c).

2. The POST method as claimed in claim 1, further comprising following steps after Step (e):
(f) outputting an error message corresponding to the POST program to the memory, when an error occurs to the POST program; and
(g) rebooting the computer and re-running the POST program.

3. The POST method as claimed in claim 1, wherein the method further comprises Step (a-1) when running Step (a) for the first time:
(a-1) setting a value of running times and a flag parameter in the memory;
wherein when a value of the times for rebooting the computer doesn't reach the value of running times, it is determined whether an error occurs to the POST program or not;
when all POST programs are completed or the value of the times for rebooting the computer has reached the value of running time, the flag parameter is set as a finished state.

4. The POST method as claimed in claim 3, further comprising a step of reading and displaying the error message corresponding to the POST program from the memory, after the step of setting the flag parameter as a finished state.

5. The POST method as claimed in claim 1, wherein the error message further includes an error occurring time data, an error occurring times data, and a detecting firmware version data.

6. The POST method as claimed in claim 1, further comprising a step ofjumping over the hardware testing program and continuing to run the POST program when the next sequence of detecting firmware is not existed after Step (d).

7. The POST method as claimed in claim 1, wherein the sequence of the detecting firmware refers to a corresponding address sequence for the detecting firmware to be stored in the memory.
